(19) United States
(12) Patent Application Publication
(10) Pub. No.: US 2014/0263907 A1
(43) Pub. Date: Sep. 18, 2014

(54) HARD DISK DRIVE MOUNTING BRACKET

(71) Applicant: Michael Andrew Mason, Boulder Creek, CA (US)

(72) Inventor: Michael Andrew Mason, Boulder Creek, CA (US)

(21) Appl. No.: 13/853,839

(22) Filed: Mar. 29, 2013

Related U.S. Application Data
(60) Provisional application No. 61/780,790, filed on Mar. 13, 2013.

(51) Int. Cl. G06F 1/18

(52) U.S. Cl. CPC G06F 1/187
USPC 248/300

(57) ABSTRACT

A hard disk drive mounting bracket allows for attaching multiple hard disk drives to a chassis and uses pre-existing chassis hardware, resulting in more efficient user of chassis space. A hard disk drive mounting bracket includes a base sheet. The base sheet includes a front region, a rear region, and a pair of side regions. The hard disk drive mounting bracket also includes a pair of support flanges disposed opposite one another in the side regions of the base sheet. The support flanges defining a receiving space that receives a plurality of hard disk drives. Each support flange includes a first end and a second end. Each first end and second end includes a mounting aperture.

### CROSS REFERENCE TO RELATED APPLICATIONS

This application claims the priority benefit of U.S. Provisional Application Ser. No. 61/780,790, titled “Hard Disk Drive Mounting Bracket,” filed Mar. 13, 2013, the disclosure of which is incorporated herein by reference.

### BACKGROUND

1. Field of the Invention

The present invention relates to mounting brackets. More specifically, it relates to hard disk drive mounting brackets that house multiple hard disk drives in a space-limited storage chassis.

2. Description of the Related Art

Hard disk drives are commonly used in servers and other computing devices to store data. Servers usually include a storage chassis that houses the hard disk drives along with other internal hardware components such as a motherboard and power supply. Because several servers are often stored in a single cabinet, server chassis are designed to maximize efficient use of their internal space. Often times, a chassis includes a hard disk drive carrier for storing disk drives within the chassis. Such carriers, however, possess limited capacities and cannot easily be expanded. Accordingly, when the carrier is full, no additional hard disk drives can be added to the server.

Others have previously attempted to solve this problem by using brackets that mount to the chassis and hold an additional hard disk drive. However, such previously attempted bracket solutions fail to allow for the efficient storage of multiple hard disk drives. Moreover, the brackets are often overly complicated and difficult to install using the existing screw holes found in server chasses. Accordingly, there is a need in the art for a hard disk drive bracket that provides for more efficient storage, makes efficient use of internal chassis space, and may be easily and quickly installed into existing chasses.

### SUMMARY

A hard disk drive mounting bracket that allows for attaching multiple hard disk drives to a chassis and uses pre-existing chassis hardware resulting in more efficient use of chassis space is provided. The mounting bracket of the present invention includes a base sheet having a front region, a rear region, and a pair of side regions. The hard disk drive mounting bracket also includes a pair of vertically oriented support flanges disposed opposite one another in the side regions of the base sheet. The vertically oriented support flanges define a receiving space that may receive a plurality of hard disk drives. Each vertically oriented support flange includes a first end and a second end, each of which include a mounting aperture for engaging multiple hard drives.

An embodiment of a hard disk drive mounting bracket may include a base sheet and a pair of support flanges. The base sheet may include a front region, a rear region, and a pair of side regions. The pair of support flanges may be disposed perpendicular to the base sheet and opposite one another in the pair of side regions of the base sheet. The support flanges may define a receiving space that receives a plurality of hard disk drives. Each vertically oriented support flange may have a first end and a second end, and each first end and second end may include a mounting aperture.

An embodiment of a mounting bracket may include a base sheet and a pair of support flanges. The base sheet may be formed by a single piece of material and may include a front region, a rear region, and a pair of side regions. The pair of support flanges may extend perpendicular from each side of the base sheet and opposite one another. Each support flange may be formed from the single piece of material and may include one or more apertures aligned with a coupling mechanism on the memory device.

### BRIEF DESCRIPTION OF DRAWINGS

FIG. 1 is a perspective view of an exemplary hard disk drive mounting bracket in accordance with the present invention.

FIG. 2 is another perspective view of an exemplary hard disk drive mounting bracket in accordance with the present invention.

FIG. 3 is a side view of an exemplary hard disk drive mounting bracket in accordance with the present invention.

FIG. 4 is a front view of an exemplary hard disk drive mounting bracket in accordance with the present invention.

FIG. 5 is a top view of an exemplary hard disk drive mounting bracket in accordance with the present invention.

### DETAILED DESCRIPTION

A hard disk drive mounting bracket of the present invention allows multiple hard disk drives to be attached in a simple manner and provides more efficient use of chassis space. The bracket may utilize existing hardware that is already part of the chassis. The bracket is mounted inside the chassis, and one more hard disk drives are mounted to the bracket within the server chassis. As such, the present invention allows for the efficient storage of multiple hard disk drives within the confined space of the server chassis. Moreover, the bracket may easily be installed using the screw holes and mounting hardware already present in the chassis. Using existing holes and mounting hardware already present in the chassis enables the hard disk drive of the present invention to be installed quickly and easily, thereby providing a simpler solution for expanding capacity of server systems than those available in the prior art.

FIG. 1 is a perspective view of an exemplary hard disk drive mounting bracket in accordance with the present invention. A hard disk drive mounting bracket 100 includes a base sheet 110. Base sheet 110 includes a front region 120, a rear region 125, and a pair of side regions 130. Base sheet 110 may include one or more ridged, bent, or curled edges 135 that provide base sheet 110 with increased strength. Base sheet 110 may include a central aperture 115 bounded by front region 120, a rear region 125, and side regions 130. Central aperture 115 may be substantially equal to the surface area of a bottom surface of a hard disk drive (shown in FIG. 3). Hard disk drive mounting bracket 100 further includes a pair of vertically oriented support flanges 140. Vertically oriented support flanges 140 are disposed opposite one another in side regions 130 of base sheet 110.

Vertically oriented support flanges 140 define a receiving space 145 that may receive one or more hard disk drives (shown in FIG. 3). In one embodiment, receiving space 145 may receive two hard disk drives. In other embodiments, receiving space 145 may receive three or more hard disk drives depending on the space available within the storage chassis (not shown). In one embodiment, receiving space 145 may receive 9 mm thick 2.5 inch hard disk drives. In other embodiments, receiving space 145 may receive 3.5″ hard disk drives, or other hard disk drives having larger or smaller dimensions. Each vertically oriented support flange 140 has a first end 150 and a second end 155. Each first end 150 and second end 155 includes a mounting aperture 160. Base sheet 110 and vertically oriented support flanges 140 may form a continuous sheet of material.

In some embodiments, hard disk drive mounting bracket 100 may include an anchor flange 165 (also shown in FIG. 5). Anchor flange 165 may be disposed on base sheet 110. Anchor flange 165 allows hard disk drive mounting bracket to be secured to the storage chassis. The storage chassis may be a server chassis, such as for example the AIC 2U 24HD storage chassis manufactured by AIC Inc. of City of Industry, Calif. In some embodiments, hard disk drive mounting bracket 100 may include multiple anchor flanges 165. In one embodiment, anchor flange 165 may extend inwardly from base sheet 110. In other embodiments, anchor flange 165 may extend outwardly as dictated by the location of the existing holes in the storage chassis. In embodiments that include central aperture 115, anchor flange 165 may extend over central aperture 115.

Base sheet 110, vertically oriented support flanges 140, and anchor flange 165 may be formed from a continuous sheet of material. The material for forming the bracket of the present invention may be chosen based on design preferences, cost, thermal requirements and method of manufacturing. Examples of suitable materials may include aluminum and steel. Each anchor flange 165 includes a hole (shown in FIG. 5) that may receive a screw, nail, rivet, pin, peg, or other suitable chassis mounting hardware known in the art. In some embodiments, each anchor flange 165 may be disposed on base sheet 110 such that its hole corresponds to an existing hole in the storage chassis, and may or may not be threaded based on the intended method of attachment. In such embodiments, the existing chassis hardware may serve as the chassis mounting hardware, thereby obviating the need to acquire and use additional hardware.

Hard disk drive mounting bracket 100 may further include a supplemental anchor flange 170. In some embodiments, hard disk drive mounting bracket 100 may include a plurality of supplemental anchor flanges 170. Supplemental anchor flange 170 may include a hole 175 that receives a screw, nail, rivet, pin, peg, or other suitable chassis mounting component known in the art. Supplemental anchor flange 170 may be disposed on base sheet 110 such that hole 175 corresponds to an existing hole in the storage chassis. In such embodiments, the existing chassis hardware may serve as the chassis mounting hardware, thereby obviating the need to acquire and use additional hardware. In one embodiments, supplemental anchor flange 170 may be fixed to base sheet 110 by rivets, screw, nails, pins, pegs, or other suitable fixing hardware known in the art.

In some embodiments, supplemental anchor flange 170 may be disposed in rear region 125 of base sheet 110, while in other embodiments it may be disposed in front region 120. Supplemental anchor flange 170 may extend inwardly, as shown in FIG. 1, or it may alternatively extend outwardly depending on the arrangement of the existing holes in the storage chassis. Accordingly, hard disk drive mounting bracket 100 may easily be adapted for use in a variety of storage chasses, each of which may feature uniquely arranged existing screw holes for mounting hardware or brackets such as the present invention.

FIG. 2 is another perspective view of an exemplary hard disk drive mounting bracket 200 in accordance with the present invention. Receiving space 210 is shown housing two stacked hard disk drives 220. Each mounting aperture 230 aligns with an existing screw hole (not shown) in a side of hard disk drive 220.

Mounting aperture 230 may be disposed in any location that best meets the design for the particular chassis, hard disk drives, and available space. For example, in hard disk drive mounting bracket 200 of FIG. 2, the mounting aperture 230 may be disposed closer to a top half of vertically oriented support flange 240. In such cases, when receiving space 210 receives hard disk drives 220 and hard disk drives 220 are secured to vertically oriented support flanges 240 through mounting apertures 230, a substantially unobstructed gap 250 remains between a bottom surface of the lowest hard disk drive 220 and base sheet 260. Gap 250 may allow for increased air flow through hard disk drive mounting bracket 200. The increased air flow may allow hard disk drives 220 to be cooled more effectively. Gap 250 may also allow for additional cables or components (not shown) to run through hard disk drive mounting bracket 200, thereby utilizing space more efficiently than previously attempted hard disk drive mounting bracket solutions.

Hard disk drives 220 may be secured to vertically oriented support flanges 240 through mounting apertures 230 by mounting hardware 270. Each mounting aperture 230 may include a plurality of wide regions that receive a shoulder of a shoulder screw and a plurality of thin regions (shown in FIG. 3). Mounting hardware 270 may include shoulder screws 280 and grommets 290. Grommets 290 may include ISODAMP grommets manufactured by E-A-R Specialty Composites of Indianapolis, Ind. Each grommet 290 may align with the wide region of mounting aperture 230 and may receive shoulder screw 280. The wide region may receive the shoulder of shoulder screw 280 with grommet 290 while the thin region may prevent subsequent movement by being narrower than inner diameter of the grommet 290. Where mounting aperture 230 includes a slot, shoulder screw 280 and grommet 290 may also be pre-installed into the existing screw holes of hard disk drive 220 and then simply slide into mounting aperture 230 without fully tightening shoulder screw 280. Doing so allows hard disk drives 220 to be easily removed from hard disk drive mounting bracket 200 without using any tools.

As persons of ordinary skill in the art will readily recognize, mounting aperture 230 may take any number of other suitable forms and may receive any number of suitable mounting hardware 270. For example, mounting aperture 230 may be a notch or a screw hole. Other suitable mounting hardware 270 may include a shoulder bolt with a washer, a ferrule, or a lock nut.

FIG. 3 is a side view of an exemplary hard disk drive mounting bracket in accordance with the present invention. As described above, each mounting aperture 310 may include both a plurality of wide regions 320 that receive a shoulder of a shoulder screw (not shown) and a plurality of thin regions 330. Vertically oriented support flanges 340 and anchor flanges 350 (shown bent into a horizontal orientation) may form a continuous sheet of material.

FIG. 4 is a front view of an exemplary hard disk drive mounting bracket in accordance with the present invention. In one embodiment, receiving space 410 may have a width of 2.924 inches. Vertically oriented support flanges 420 may have a height of 1.179 inches.

FIG. 5 is a top view of an exemplary hard disk drive mounting bracket in accordance with the present invention. In an embodiment, hard disk drive mounting bracket 500 may have the exemplary dimensions shown in FIG. 5. For example, base sheet 510 may have a width 520 of 3.895 inches, and anchor flanges 530 may be separated by a distance 540 of 1.385 inches from midpoint to midpoint. In other embodiments, hard disk drive mounting bracket 500 may have other dimensions depending on the size of the hard disk drives, the size of the storage chassis, and the location of the existing screw holes in the storage chassis.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A hard disk drive mounting bracket, comprising:
a base sheet including a front region, a rear region, and a pair of side regions; and
a pair of support flanges disposed perpendicular to the base sheet and opposite one another in the pair of side regions of the base sheet, the support flanges defining a receiving space that receives a plurality of hard disk drives, each support flange having a first end and a second end, each first end and second end including a mounting aperture.

2. The hard disk drive mounting bracket of claim 1, further comprising an anchor flange disposed on the base sheet.

3. The hard disk drive mounting bracket of claim 1, wherein the base sheet further includes a central void bounded by the front region, the rear region, and the side regions.

4. The hard disk drive mounting bracket of claim 2, wherein the anchor flange extends inwardly over the central void.

5. The hard disk drive mounting bracket of claim 3, wherein the area of the central void is substantially equal to the surface area of a bottom surface of a hard disk drive.

6. The hard disk drive mounting bracket of claim 1, wherein the base sheet and the support flanges are manufactured as a single continuous sheet of material.

7. The hard disk drive mounting bracket of claim 2, wherein the base sheet, the support flanges, and the anchor flange form a continuous sheet of material.

8. The hard disk drive mounting bracket of claim 1, wherein each mounting aperture includes a plurality of wide regions that receive a shoulder of a shoulder screw and a plurality of thin regions.

9. The hard disk drive mounting bracket of claim 1, wherein the mounting apertures align with a plurality of existing screw holes in the side of a hard disk drive.

10. The hard disk drive mounting bracket of claim 1, further comprising a supplemental anchor flange.

11. The hard disk drive mounting bracket of claim 1, wherein the base sheet further includes one or more curled edges.

12. A mounting bracket for a memory device, comprising:
a base sheet formed by a single piece of material, the base sheet including a front region, a rear region, and a pair of side regions; and
a pair of support flanges extending perpendicular from each side of the base sheet and opposite one another, each support flange formed from the single piece of material and including one or more apertures aligned with a coupling mechanism on the memory device.

13. The mounting bracket of claim 12, further comprising an anchor flange disposed on the base sheet.

14. The mounting bracket of claim 12, wherein the base sheet further includes a central void bounded by the front region, the rear region, and the side regions.

15. The mounting bracket of claim 13, wherein the anchor flange extends inwardly over the central void.

16. The mounting bracket of claim 14, wherein the area of the central void is substantially equal to the surface area of a bottom surface of a hard disk drive.

17. The mounting bracket of claim 12, wherein the base sheet and the support flanges are manufactured as a single continuous sheet of material.

18. The hard disk drive mounting bracket of claim 2, wherein the base sheet, the support flanges, and the anchor flange form a continuous sheet of material.

19. The mounting bracket of claim 12, wherein each mounting aperture includes a plurality of wide regions that receive a shoulder of a shoulder screw and a plurality of thin regions.

20. The mounting bracket of claim 12, wherein the mounting apertures align with a plurality of existing screw holes in the side of a hard disk drive.

21. The mounting bracket of claim 12, further comprising a supplemental anchor flange.

22. The mounting bracket of claim 12, wherein the base sheet further includes one or more curled edges.
